(19) United States
(12) Patent Application Publication
(10) Pub. No.: US 2005/0015438 A1
(43) Pub. Date: Jan. 20, 2005

(54) Virtual data hosting

(76) Inventor: Jin Teik Teh, Los Altos, CA (US)

Correspondence Address: SUPREME PATENT SERVICES, POST OFFICE BOX 2339, SARATOGA, CA, 95070, US

(21) Appl. No.: 10/600,852

(22) Filed: Jun. 19, 2003

(51) Int. Cl. G06F 15/16

(52) U.S. Cl. 709/203

(57) ABSTRACT

The present invention is a virtual data hosting method that can be used in a system comprising a set of computer programs that resides on a remote computing environment, called the platform server, and a client program that resides on a portable wired or wireless device, called the platform client. When user accesses data, the platform client determines if the data is already on the client. If it is, it loads the data. If the application is not on the client, the platform client retrieves the data from the platform server. During the aforementioned data accessing, the user is unaware of the location where the data is retrieved from. The present invention is a virtual data hosting server that employs scalable and distributed technologies to provide a mechanism to users that all the data is hosted by the data hosting server.

### FIELD OF THE INVENTION

This invention relates to a method for data hosting in a data accessing system, and more, in particular, to a method of virtual data hosting in a data accessing system that allows both wired and wireless retrieving.

### BACKGROUND OF THE INVENTION

Due to the rapid progress in the wired and wireless communication, more and more data access systems are developed in order to provide users of mobile devices the access to a wide range and large amount of applications and data. These systems aim to provide users with a seamless and easy access to various applications and data on a subscription basis. Take portable wireless devices as an example. Users want to be able to bring along their data with them or have access to their data wherever they go.

However, when the number of the users accessing to the system is large, the performance would become inhibitively slow. A possible solution for this problem is a mechanism that would alleviate certain data access loadings from the data access system. A data hosting server is an application server for this purpose. It provides hosting services for information such as text message, picture messages, emails, phonebook records, uploaded image and audio files, stock portfolios and subscription information.

Another important designing criterion is that the data hosting services must allow the user to access data without being aware of whereabouts of the data location, and regardless of data types. In short, it is imperative for a data hosting server to provide a mechanism that, from the user's point of view, all data is hosted by the hosting server. However, this does not mean that the data is solely stored at the hosting server. Instead, the data could be scattered across servers, or on other application servers at different locations around the world. The user only sees the data in one location, but the data may, in fact, be stored in multiple locations.

### SUMMARY OF THE INVENTION

The present invention is a virtual data hosting method that can be used in a system comprising a set of computer programs that resides on a remote computing environment, called the platform server, and a client program that resides on a portable wired or wireless device, called the platform client. The platform server maintains a list of applications and data that a user can access, while the platform client contains a partial view into the list of applications and data that is stored on the platform server. When the user accesses data, the platform client determines if the data is already on the client. If it is, it loads the data. If the application is not on the client, the platform client retrieves the data from the platform server. During the aforementioned data accessing, the user is unaware of the location where the data is retrieved from. The present invention is a virtual data hosting server that employs scalable and distributed technologies to provide a mechanism to users as if all the data is hosted by the data hosting server.

The uniqueness of the present invention comes from that the accessing devices only need to access one location for all the user's data. For handheld devices, it is very inconvenient for the user to access data from different locations, or try to integrate data from different sources.

The present invention will become more obvious from the following description when taken in connection with the accompanying drawings which show, for purpose of illustration only, a preferred embodiment in accordance with the present invention.

### BRIEF DESCRIPTION OF THE DRAWING

The foregoing aspects and many of the attendant advantages of this invention will become more readily appreciated as the same becomes better understood by reference to the following detailed description, when taken in conjunction with the accompanying drawings, wherein:

FIG. 1 depicts a diagram showing a data management system between a platform server and a platform client; and

FIG. 2 depicts a diagram showing the scalability and load balancing design of the system in the present invention.

### DETAILED DESCRIPTION OF THE INVENTION

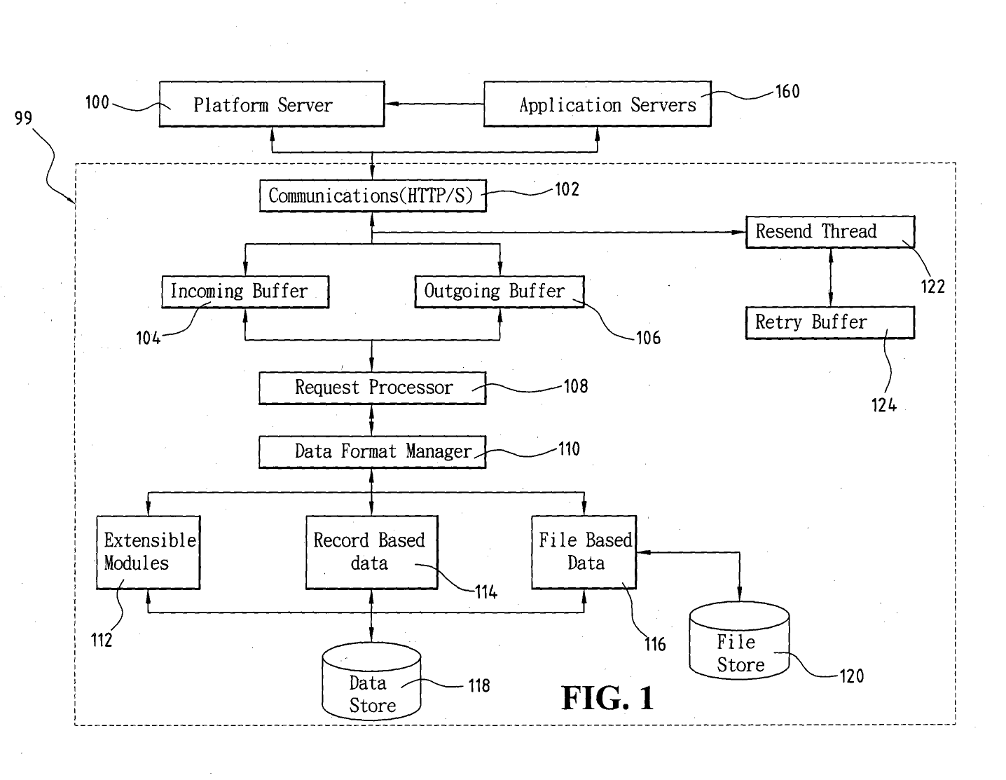

A pictorial representation of hosting server internal architecture is shown in FIG. 1, which comprises a platform server 100, a plurality of application servers 160, and a hosting server 99. The platform server 100 provides generic functionality for managing all application and data that belong to users. While the application servers 160 are servers that manage all processes and tasks specific to an application or product or service. Usually this would reside outside the customer's local area network. Application client (not shown) is a separate module or process that resides on the client that provides a specific task for the client, it can be a specialized application that handles drawing of vector graphics or the playing of MP3 audio files, input and transactions of stock trades, or any other applications. On the other hand, the hosting server 99 sits outside the platform server 100 because it must be accessible from the application server 160. It communicates with the platform server 100 as an application server 160 does. Furthermore, the hosting server 99 consists of a request processor 108 that handles all incoming message from the platform server 100 and application servers 160 while the application servers 160 are primarily to handle the application control logic and non-personal data. It must be noted that in this invention all read and write from and to personal data must be made through the hosting server 99. This gives the users a sense that all the accessed data are stored at and retrieved from the same location.

The data hosting server 99 as shown in FIG. 1, further comprising a communication module 102, an incoming buffer 104, an outgoing buffer 106, a request processor 108, a data format manager 110 for managing an extensible modules 112, a record-based data 114 format, and a file-base data 116 format, a data store 118, a file store 120 for storing file-based data 116, a resend thread process 122 and a retry buffer 124 used by the resend thread 124.

The communications module 102 accepts requests in HTTP, binary RPC (remote procedure call protocol) or other protocol from the platform server 100 and application servers 160. It can also connect the platform server 100 or the application servers 160 to return the results of a request. The hosting server 99, for example, may be implemented as an application server 160 with an HTTP, an RPC, or other protocol interface.

The incoming buffer 104 stores all incoming messages. The messages are received from the platform server 100 or from application servers 160. When a new message is received, the request process 108 is notified of the new message. On the other hand, the outgoing buffer 106 stores all outgoing message to be sent to the platform server 100 or the application servers 160. When a new message is received, the communications is notified so that it can be sent out.

The request processor 108 handles all incoming and outgoing requests. Incoming messages from the platform server 100 are passed to the data format manager 110 for processing in accordance with their data type. The application manager 110 manages all the available data format modules in the data hosting server, such as a record-based data format 114 and a file-based data format 116, as well as an extensible module 112 that allows to the data server to add new data format module when necessary. Examples of record based formats 114 are phoneBook records, calendar records and messaging records, and examples of file based formats 116 are photo, audio and multimedia files. All hosted data are stored in the data store 118, and the file store 120.

The retry buffer 124 stores all outgoing messages that failed to be sent to the application server 160 or platform server 100. The messages will be retried after a preset number of times. The resend thread 122 picks up messages from the retry buffer 124 at specified intervals for resending.

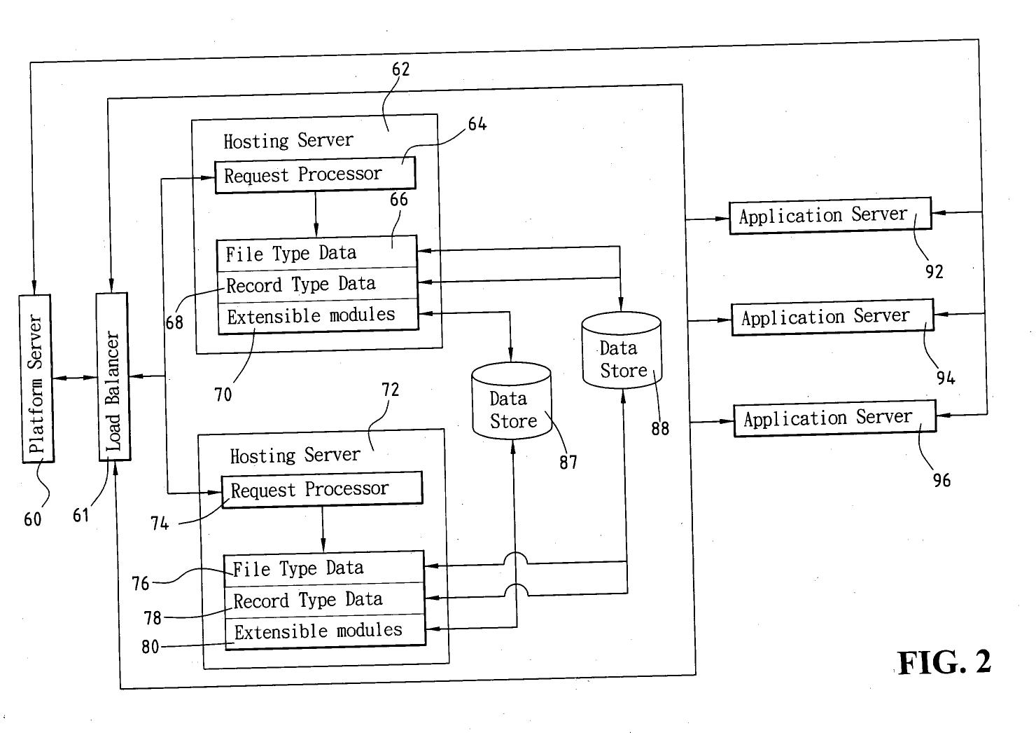

For a system of a large user base, it is imperative to design with scalability in mind. Scalability usually delivers better performance and provides additional benefits, such as flexibility, load-balancing or fault-tolerance. The present invention employs distributed technology so that the data hosting server can be distributed among multiple servers without affecting usability and functionality. In FIG. 2, a scalable system design is shown. When the platform server 60 receives data accessing requests, it passes the requests to the load balancer 61. The load balancer 61, based on the workload of each hosting server, determines which hosting server will process the request. There are two hosting servers 62, 72 shown in FIG. 2. Each hosting server 62, 72 may comprise the identical architecture as shown in FIG. 1. To simplify the drawing, only request processor and data type modules are drawn in FIG. 2: the hosting server 62 consists of request processor 64 to handle the access of data format which consists of file type data 66, record type data 68, extensible modules 70 for further needed data format while the other hosting server 72 consists of another request processor 74 to handle the access of data format which consists of file type data 76, record type data 78, extensible modules 80 for further needed data format. The data of extensible modules 70, 80 are stored at data store 87, while the file type data 66, 76 and record type data 68, 78 are stored in data store 88. The load balancer 61 is responsible for distributing the tasks between the hosting server 62, 72. On the application end, the application server 92, 94, 96 can be scattered and distributed all over the world. In fact, each application module can access different data stores or database. As the major storage requirement is in the data store 87, 88, this design allows dedicating various stores to applications that require the most data storage. In addition, each hosting server 62, 72 must have the same configuration of application modules 92, 94, 96. This allows identical integration features between applications to be available by each hosting server 62, 72.

As seen from the aforementioned embodiment, the present invention provides a virtual data hosting service which makes it easy for the users to access all their data from one location, even when the data are physically scattered at different locations. The centralization of the access of data also allows easier data integration, which is another important requirement for many users.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modification and similar structure.

While the preferred embodiment of the invention has been illustrated and described, it will be appreciated that various changes can be made therein without departing from the spirit and scope of the invention.

1. In a wireless data delivery system serving a plurality of types of wireless devices and a plurality of application servers, a method of virtual data hosting using a plurality of data hosting servers, said method comprising:
(1). accepting data access requests from said devices;
(2). distributing said requests to a suitable data hosting server for processing;
(3). said suitable data hosting server process said request, and delivers requested data to said devices.

2. The method of virtual data hosting as claimed in claim 1, wherein said suitable data hosting server has the same configuration as said application servers.

3. The method of virtual data hosting as claimed in claim 1, wherein said distributing said requests step can distribute said requests to said data hosting servers scattered at different geographical locations.

4. The method of virtual data hosting as claimed in claim 1, wherein said distributing said requests step is performed by a load balancer which determines the suitability of said data hosting server based on their work load.

5. The method of virtual data hosting as claimed in claim 1, wherein said distributing said requests step is performed by a load balancer which determines the suitability based on type of data requested.

6. A virtual data hosting system comprising:
(1). a load balancer;
(2). a plurality of data hosting servers;
(3). a plurality of data store; and
(4). a network providing communication links between said load balancer, said data hosting servers and data stores.

7. A virtual data hosting system as claimed in claim 6, wherein said load balancer is a software program that determines the distributing of requests among said data hosting servers.

8. A virtual data hosting system as claimed in claim 6, wherein said data hosting servers have the same configuration as said application servers within the same cluster so that they can serve all the applications.

9. An apparatus used in a wireless data delivery system serving a plurality of types of wireless devices and a plurality of application servers, said apparatus comprising:
a memory storing a program, and
a processor responsive to the program to:
(1). accepting data access requests from said devices;
(2). processing said requests; and
(3). delivering requested data to said devices.

10. The apparatus as claimed in claim 9, wherein said memory is a harddisk.

11. A data hosting server comprising an apparatus, said apparatus further comprising:
a memory storing a program, and
a processor responsive to the program to:
(1). accepting data access requests from said devices;
(2). processing said requests; and
(3). delivering requested data to said devices.

12. The data hosting server as claimed in claim 11, wherein said memory is a hard disk.
